(19) United States
(12) Patent Application Publication
(10) Pub. No.: US 2003/0143939 A1
(43) Pub. Date: Jul. 31, 2003

(54) Portable and rechargeable fish scaler devices

(76) Inventors: James Barlow, Greenville, FL (US); E. Carol Barlow, Greenville, FL (US)

Correspondence Address: Carnes, Cona & Associates, Innovation Park, 1736 West Paul Dirac Drive, Tallahassee, FL, 32310-3763, US

(21) Appl. No.: 10/338,141

(22) Filed: Jan. 8, 2003

Related U.S. Application Data
(60) Provisional application No. 60/347,100, filed on Jan. 11, 2002.

(51) Int. Cl. A22C 25/02

(52) U.S. Cl. 452/101

(57) ABSTRACT

The present invention are powered devices for removing scales from fish. A scaling element consisting of three or more blunt edged radial arms are provided with a shaft. The shaft is secured to, or configured to be retained by, a battery powered portable drive. The drive imparts a rotation motion to the scaling element which is pressed to the skin of a fish in operation. The drive may be a portable battery powered consumer drill. The blunt edges provide safety from accidental contact with the user. The invention provides a low cost and safe method of scaling fish.

### BACKGROUND OF THE INVENTION

1. Field of the Invention

The present invention relates generally to a novel and unique user-friendly portable and rechargeable fish scaler and more particularly to portable and rechargeable fish scaler devices which are designed and configured to enhance the scaling process of various types and sizes of fish.

2. Description of the Prior Art

Fishing is a popular recreational sport enjoyed by many throughout the United States. People fish in many different bodies of water including lakes, rivers, streams, oceans and bays. Depending on the type of fish caught, it may or may not contain scales on its body that must be scaled prior to eating. Catching fish that are large enough to be kept is the most exciting part of fishing, however, a “keeper” with scales requires scaling. The task of scaling a fish is the least favorite aspect of fishing.

It is seen in the prior art that numerous scaling devices have been developed to overcome the problems associated with current scaling devices. For example, U.S. Pat. No. 4,667,372 issued to Till wherein is disclosed a fish scaler adapted to receive an electric drill chuck comprising a rotary assembly with a plurality of scale flicker rods for removal of fish scales. Although this device may be efficient in the removal of fish scales without causing bruising to the fish, this device has many safety issues. For instance, the device disclosed by Till is driven by an electric drill, which presents added danger of electrocution to the user if the device is being utilized around water, such as on a boat dock or pier. In addition, this invention is very susceptible to severe finger damage to the user. Also, this prior device lacks the advantage of portability as with the device of the present invention.

Yet another example is seen in U.S. Pat. No. 4,271,562 issued to Penner wherein is disclosed a fish scaler which operates by means of electric power, or by a power take-off from any engine. This device also suffers many shortcomings. Although this device does offer portability to some degree, this device is very dangerous to the user, as there is no guard over the wires or blades which could easily cut the user, or mangle a finger.

Another example is seen in U.S. Pat. No. 3,590,424 issued to Shultz wherein disclosed is a battery operated fish scaling device which is powered by a motor in the handle and utilizes three rotating blades that cut into the fish, and thus remove the scales. This device also provides for a guard rail which will limit the depth of the cut of the blades into the fish. The area surrounding the blades of this fish scaling device is open so as to prevent clogging portions of the device.

What is needed is a fish scaling device that can be utilized safely and efficiently and is substantially traditional in appearance so as to provide for a final product that is simple in design and structure and which will prove successful in achieving the desired results.

Hence, it is seen that none of these previous inventions provide the benefits intended with the present invention, such as providing a safe fish scaling device. Additionally, prior techniques do not suggest the present inventive combination of component elements as disclosed and claimed herein. The present invention achieves its intended purposes, objectives and advantages over the prior art devices through a new, useful and unobvious combination of component elements, which is simple to use, with the utilization of a minimum number of functioning parts, at a reasonable cost to manufacture, assemble, test and by employing only readily available material.

### SUMMARY OF THE INVENTION

The present invention is a novel and unique portable and a rechargeable power-driven fish scaler rotary device that is ideally suited to enhance the scaling process of various types and sizes of fish. Preferably, this fish scaler apparatus of the present invention comprises a three-sided rotary device including an elongated support shaft or rod which is configured to be received in the chuck of a portable and rechargeable power-driven drill or the like.

Located on one end there is a three, or more, sided rotary device, while located at the second end is an elongated support shaft or rod. To enable for the device to be used with either hand and be portable and rechargeable, the elongated support shaft or rod is removably secured to the chuck of a portable and rechargeable battery power-driven drill or the like.

A kit of the present invention also provides for a sharpening stone and rock. In various embodiments, the present invention comprises four or five-sided rotary device with blunt edges. In yet a further embodiment the blunt edges are integral to rods extending from the driven shaft in an “egg-beater” configuration.

Accordingly, it is an object of the present invention to provide for a portable and rechargeable fish scaling device and attachments which will overcome the deficiencies, shortcomings, and drawbacks of prior scaling devices geared specifically towards those high-voltage electrically powered or those which provide for other safety concerns including finger injuries or the like.

Still another object of the present invention is to provide for a fish scaling device that is completely portable and may be quickly and easily rechargeable.

A further object of the present invention is to provide for a fish scaling device that may be utilized by a right-handed person, as well as a left-handed person.

Still a further object of the present invention, to be specifically enumerated herein, is to provide a fish scaling device and attachments in accordance with the preceding objects and which will conform to conventional forms of manufacture, be of simple construction and easy to use so as to provide a device that would be economically feasible, long lasting and relatively trouble free in operation.

Although there have been inventions related to fish scaling devices, none of the inventions have become sufficiently compact, low cost, functional and reliable enough to become commonly used. The present invention meets the requirements of functionality, simplified design, compact size, low initial cost, low operating cost, ease of installation and maintainability, and a minimal amount of training to successfully employ the invention.

The foregoing has outlined some of the more pertinent objects of the invention. These objects should be construed to be merely illustrative of some of the more prominent features and applications of the intended invention. Many other beneficial results can be obtained by applying the disclosed invention in a different manner or modifying the invention within the scope of the disclosure. Accordingly, a fuller understanding of the invention may be had by referring to the detailed description of the preferred embodiments in addition to the scope of the invention taken in conjunction with the accompanying drawings.

### BRIEF DESCRIPTION OF THE DRAWINGS

FIG. 1 is a side view of the fish scaling device of a preferred embodiment of the present invention including a powered rotary drive.

FIG. 2 is a cross-section view of the embodiment of FIG. 1.

FIG. 3 is a cross-section view of an alternative embodiment of the invention.

FIG. 4 is side view of an alternative embodiment of the invention.

FIG. 5 is an enlarged cross-section view of the embodiment of FIG. 4.

FIG. 6 is side view of yet another embodiment of the invention having an “egg-beater” configuration.

FIG. 7 is an enlarged cross-section view of the embodiment of FIG. 6.

### PREFERRED EMBODIMENTS OF THE PRESENT INVENTION

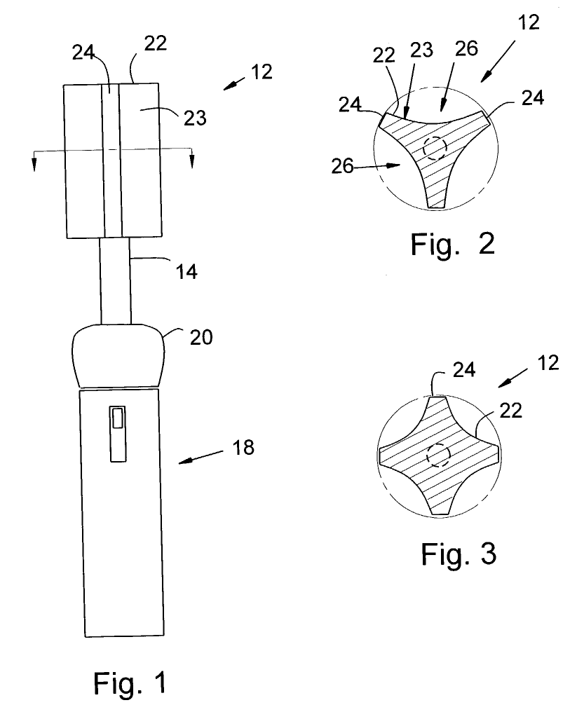

FIGS. 1 and 2 show a preferred embodiment of the fish scaling device of the present invention. The device includes a scaling element 12 extending from the distal end of an elongated support shaft 14. The proximal end of the shaft 14 is secured to a power drive 18 configured to rotate the shaft and scaling element 12. The power drive 18 shown includes a releasable chuck 20 to receive and retain the shaft 14, although the shaft may, alternatively, be integral to the drive. An example power drive is any of various currently marketed consumer portable rechargeable battery powered drills for accepting drill bits or the like.

The scaling element 12 includes three radially extending arms 22, each of which terminates at an outward facing blunt or flat end 24. The ends are equidistant from the axis of the shaft 14. The arms 22 may be defined by concave valleys 26 separating the ends 24. The depth of the valleys 26 must be sufficient to present the edge of the end 24 when rotating.

In operation, the power drive 18 imparts rotation of the scaling element about the axis of the shaft 14. When the scaling element ends 24 are pressed against the skin of a scaled fish, the scaled are disrupted and removed. It has been found that the scaling element need not be sharp at the ends to effect this result. Consequently, to gain the advantage of safety to the user, the current invention preferably has blunt edges. Herein “blunt edges” is meant to indicate that the intersection of the scaling element end 24 and the sides 23 of the supporting arms do not define a discontinuity. Rather, each arm 22 and end is relatively smooth. Such a device, when inadvertently touched by a user while operating, will not cut the user. The scaling element is preferably formed of molded high density plastic. Although metal construction will also be effective, the higher weight and cost of metals are contrary to the aims of the invention. The axial or longitudinal dimension of the scaling element is not limited although for practical use a length (measured along the ends 24) of at least one inch and less than six inches is preferred.

FIG. 3 depicts a cross-section view of an alternative embodiment of the scaling element 12 of the invention. This embodiment includes four arms 22 and ends 24 formed and operating in a manner as discussed above. In further alternatives not shown the invention includes greater than four arms, although greater than five arms may reduce the effectiveness of operation. Note that preferably the ends have similary blunt edges at both edges. This provides for operation with rotation in either direction. In all embodiments, the arms are symmetrically oriented about the axis.

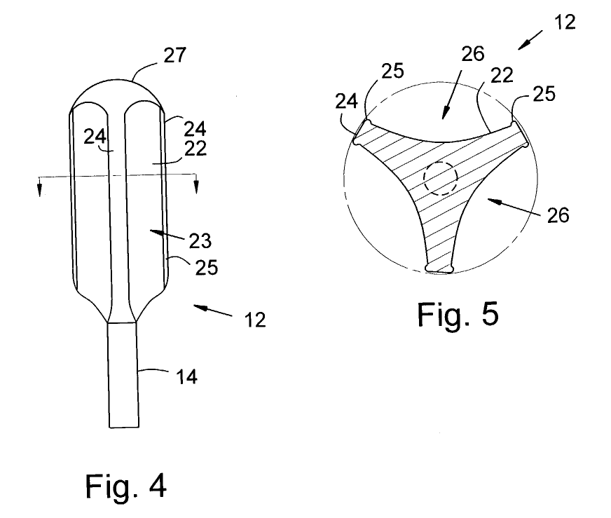

FIGS. 4 and 5 depict a further embodiment of the invention including a scaling element 12 having ends 24 which overhang the supporting arms 22. The overhanging ends 24 have a circumferential dimension greater than the adjacent arms. At the same time the ends have a smooth blunt edge 25. This configuration may be incorporated with any of the embodiments discussed herein. In addition, FIG. 4 illustrates a rounded head 27 which projects axially from the arms. This element provides further safety by reducing the chance of accidental contact with the rotating arms during use. This feature, also, may be incorporated with any of the embodiments discussed herein.

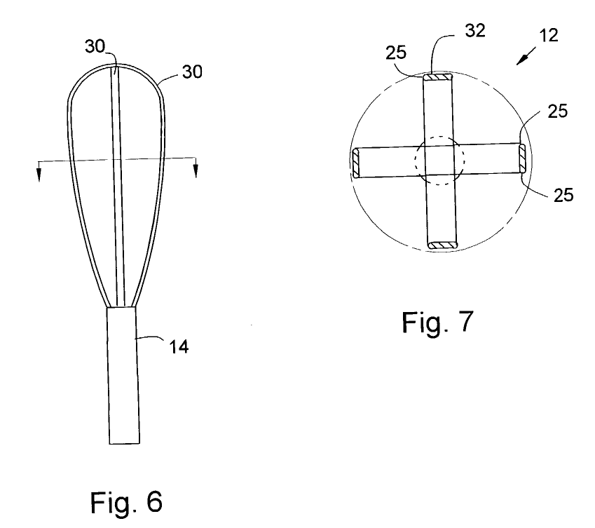

In another alternative embodiment of the present invention shown in FIGS. 6 and 7, the device provides four prismatic rails or rods 30 which extend from a shaft 14 to a second end. The rods 30 are equally spaced from the shaft axis. The cross-section of each rod 30 is generally ovulated or rounded to present a blunt edge 25 in the circumferential direction. As shown, the four arms are formed from two segments bent in symmetrical form. Alternatively, the arms may be interconnected by thin walls to protect against insertion of the users fingers.

The invention includes a kit having one or more scaling devices and a power drive unit. The invention also includes methods of scaling fish in which the above described devices are employed as designed to descale fish while providing safety and convenience to users.

While the invention has been particularly shown and described with reference to an embodiment thereof, it will be understood by those skilled in the art that various changes in form and detail may be made without departing from the spirit and scope of the invention.

I claim:

1. A low-cost and safe fish scaling device comprising:
a drive shaft having a proximal and distal end;
at least three integral radial arms extending longitudinally from the distal end, each arm terminating, in the radial direction, at a outward facing end; and each arm and respective end joining at a blunt edge.

2. The device of claim 1, wherein:
at least three arms comprises three arms.

3. The device of claim 1, further comprising:
a power drive secured to the drive shaft proximal end.

4. The device of claim 3, wherein:
the power drive is removably secured to the drive shaft.

5. The device of claim 1, wherein:
the arms are formed of plastic.

6. The device of claim 5, further comprising:
a rounded head projecting axially from the arms.

7. A low-cost and safe fish scaling device comprising:
a shaft having a proximal and distal end and an axis;
a scaling element extending from the distal end, the scaling element comprising:
at least three plastic integral arms, the arms having blunt edges at a common radial dimension.

8. A fish scaling kit comprising:
a power drive; and
at least one scaling element;
each scaling element comprising:
at least three plastic integral arms, the arms terminating at blunt edges at a common radial dimension; and an shaft extending from the arms and configured to be received by the power drive.

9. A method of safely scaling fish comprising:
rotating the device of claim 4 while the scaling element is pressed against a fish such that the blunt edges remove scales from the fish.
